(19) United States
(12) Patent Application Publication
(10) Pub. No.: US 2015/0154613 A1
(43) Pub. Date: Jun. 4, 2015

(54) COMPETITOR ANALYTICS

(71) Applicant: Google Inc., (US)

(72) Inventor: Michael MA, Mountain View, CA (US)

(73) Assignee: Google Inc., Mountain View, CA (US)

(21) Appl. No.: 13/779,684

(22) Filed: Feb. 27, 2013

(51) Int. Cl. G06Q 30/02

(52) U.S. Cl. CPC G06Q 30/0201

(57) ABSTRACT

A system and a computer implemented method for providing a business with reputation data, the method including receiving a request to provide a business with competitor analytics regarding the business, identifying one or more competitors of the business, where each of the one or more competitors of the business include a business, collecting from one or more reputation data sources reputation data corresponding to the business, generating review metrics regarding the business based on the reputation data corresponding to the business, collecting from the one or more reputation data sources reputation data corresponding to the one or more competitors, generating review metrics regarding the one or more competitors based on the reputation data corresponding to the business and providing the review metrics regarding the business and the review metrics regarding the one or more competitors for display in response to the request.

### BACKGROUND

Merchants typically compete with other businesses within their field of business and/or geographic area. It is useful for merchants, when assessing the reputation of their business, to compare their business reputation to the reputation of their competitors. To do this, businesses must keep track of who they compete with in the market, and stay up to date with their competitors to determine the reputation of each competitor in relation to their own business. This process is burdensome as it requires merchants to be aware of all of their competitors and to keep track of their own reputation as well as the reputation of their competitors manually.

### SUMMARY

The disclosed subject matter relates to a computer implemented method for providing a business with reputation data, the method comprising receiving, at one or more computing devices, a request to provide a business with competitor analytics regarding the business. The method further comprising identifying, using the one or more computing devices, one or more competitors of the business, wherein each of the one or more competitors of the business comprise a business. The method further comprising collecting, using the one or more computing devices, from one or more reputation data sources reputation data corresponding to the business. The method further comprising generating, using the one or more computing devices, review metrics regarding the business based on the reputation data corresponding to the business. The method further comprising collecting, using the one or more computing devices, from the one or more reputation data sources reputation data corresponding to the one or more competitors. The method further comprising generating, using the one or more computing devices, review metrics regarding the one or more competitors based on the reputation data corresponding to the business and providing, using the one or more computing devices, the review metrics regarding the business and the review metrics regarding the one or more competitors for display in response to the request.

The disclosed subject matter also relates to a system for providing a business with reputation data, the system comprising one or more processors and a machine-readable medium comprising instructions stored therein, which when executed by the processors, cause the processors to perform operations comprising receiving a request to provide a business with competitor analytics. The operations further comprising identifying one or more competitors of the business according to the geographic location of the business and business category associated with the business, wherein each of the one or more competitors of the business comprise a business. The operations further comprising collecting from one or more reputation data sources reputation data corresponding to the business and the one or more competitors and generating review metrics regarding one or more of the business and the one or more competitors based on the reputation data.

The disclosed subject matter also relates to a machine-readable medium comprising instructions stored therein, which when executed by a machine, cause the machine to perform operations comprising receiving a request to provide a business with competitor analytics regarding the business. The operations further comprising identifying one or more competitors of the business, wherein each of the one or more competitors of the business comprise a business. The operations further comprising collecting from one or more reputation data sources reputation data corresponding to the business and one or more competitors of the business. The operations further comprising generating review metrics regarding one or more of the business and the one or more competitors of the business based on the reputation data and providing the review metrics regarding the business and the review metrics regarding the one or more competitors for display in response to the request.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims.

However, for purpose of explanation, several embodiments of the subject technology are set forth in the following figures.

FIG. 1 illustrates an example client-server network environment which provides for providing competitor analytics to a business.

FIG. 2 illustrates a flow diagram of an example process for providing competitor analytics to a business or an agent of the business (“user”).

FIG. 3 illustrates a flow diagram of an example process for providing reputation data regarding a business.

FIG. 4 illustrates an example graphical user interface for selecting one or more data sources for monitoring.

FIG. 5 illustrates an example graphical user interface for providing reputation data regarding a business.

FIG. 6 illustrates an example graphical user interface displaying competitor analytics.

FIG. 7 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The subject disclosure provides a method and system for providing a business with competitor analytics including analysis of reputation data regarding the business and one or more individual competitors, and/or a group of competitors. A business may, in some instances, explicitly identify certain businesses as its competitor. Additionally, competitors may be identified using information such as the geographic location of the business and/or business category of the business (e.g., type of business, products and services offered by the business, and other identifying data regarding one or more categories in which a business operates). The information, including the geographic location and the business category of the business, is used to identify businesses that are likely to be a competitor (e.g., offering same or similar products or services, within the same category, and/or geographical proximity).

In one example, the geographic location and/or business category of the business may be predefined (e.g., manually entered by the business, or determined based on readily available information). In another example, one or both the geographic location and business category of the business may be determined based on one or more criteria including information regarding the business or business activity. Similarly, the geographic location and/or business category of competitor businesses may be known and/or may be determined based on one or more criteria including information regarding the competitor and competitor activity.

The geographic location of a business and/or one or more competitors may be based on structured data (e.g., data specifically indicating geographic location) and/or unstructured data (e.g., data providing some indication of geographic location without explicitly being stated as a specific geographic location). The unstructured data, for example, may include, the geographic location of one or more customers of the business, the proximity of a business to one or more other businesses, geographic related customer activity (e.g., check-ins), and other similar information that may provide information that may be used to determine (e.g., estimate) the geographic location of a business.

The business category of a business and/or one or more competitors may similarly be based on structured category data (e.g., data specifically indicating business category) and/or unstructured category data (e.g., data providing some indication of business category but not explicitly being stated as a specific category of business). Where the business category of a business and/or one or more competitor is based, at least in part, on unstructured category data, the criteria for determining a business category of the business and/or one or more competitors may, for example, include, information regarding the types of products or services of the business or competitor business, business type information, content of reviews and/or user feedback, and/or other similar indicators of the business category of the business and/or one or more competitors.

Once the competitors of the business are identified, reputation indicators (e.g., reviews and feedback information provided by consumers) regarding each competitor as well as the business are collected from different data sources, including various web sites and services (e.g., online or offline) providing comment and review capabilities to consumers of the business. The reputation data for each competitor and/or the business is then aggregated to generate various reputation metrics regarding the business and one or more of its competitors (e.g., individually and/or in aggregate). The reputation metrics may include various indicators of the reputation of the business and/or one or more of its competitors including number of reviews, data source of reviews, ratings (across all services and/or data source specific), and other information generated from reviews and comments collected regarding the business and/or one or more of its competitors.

The reputation metrics may be provided for display to the business, thus allowing the business to compare its reputation with other competitors, with a group of competitors, and/or the overall competitor market. The information provided for display to the business (e.g., an agent of the business) may include average rating of competitors, sample reviews, highest ranking or lowest ranking competitors, and other similar information.

II. Example Client-Server Network Environments for Providing a Business with Competitor Analytics

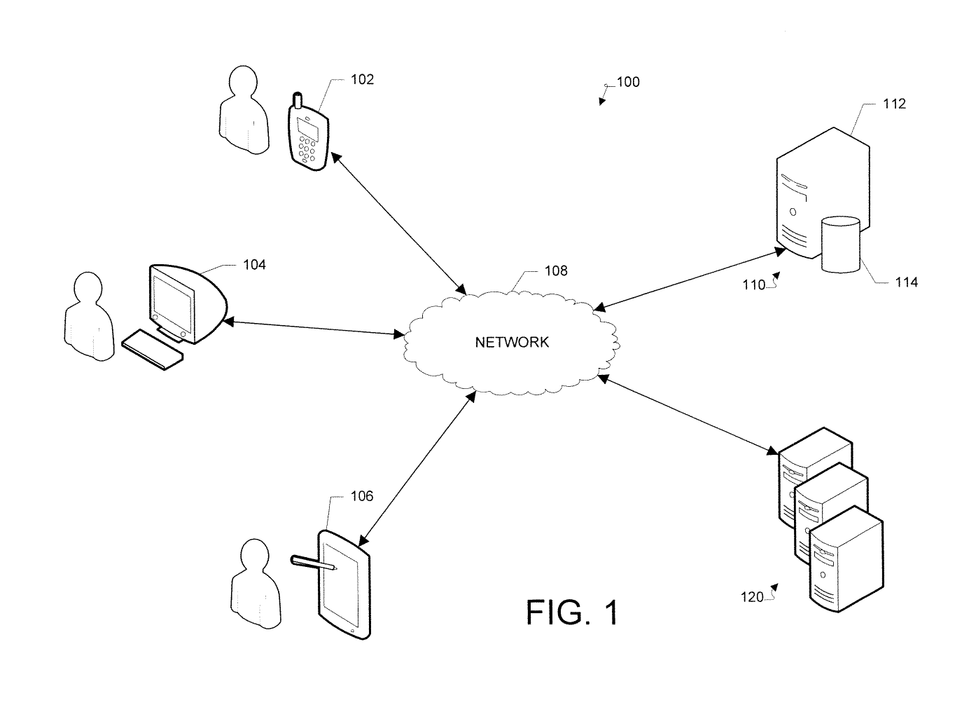

FIG. 1 illustrates an example client-server network environment which provides for providing competitor analytics to a business. A network environment 100 includes a number of electronic devices 102, 104 and 106 communicably connected to a server 110 by a network 108. One or more remote servers 120 may be further coupled to the server 110 and/or the one or more electronic devices 102, 104 and 106. Server 110 includes a processing device 112 and a data store 114. Processing device 112 executes computer instructions stored in data store 114, for example, to assist in providing competitor analytics to a user (e.g., a business or agent of a business) at electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a computer-generated information such as a web page or web application. In one example, the electronic devices 102, 104 and 106 store a user agent such as a browser or application for viewing competitor analytics data. In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing device working together to perform the actions of a server computer (e.g., cloud computing). The server 110 may host a web server communicationally coupled to the browser at the client device (e.g., electronic devices 102, 104 or 106) via network 108. In one example, the server 110 may host the system and/or the local service for providing competitor analytics to a business agent (e.g., user).

Each of the one or more remote servers 120 can be a single computing device such as a computer server or can represent more than one computing device working together to perform the actions of a server computer (e.g., cloud computing). Each of the one or more remote servers 120 may host one or more web servers, web pages, and/or applications, including various computer-implemented applications providing reputation data regarding a user and one or more competitors, information regarding the business and/or one or more competitors, or logic for determining information regarding a competitor and/or business. In one embodiment server 110 and one or more remote servers 120 may be implemented as a single server hosting the system or application for providing competitor analytics, one or more databases for storing information regarding the business and/or one or more competitors and/or applications for allowing users (e.g., customers) to provide reputation data regarding a business (e.g., websites and/or applications). In one example, the server 110 and one or more remote servers 120 may communicate through the user agent at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Processes for Providing a Business with Competitor Analytics

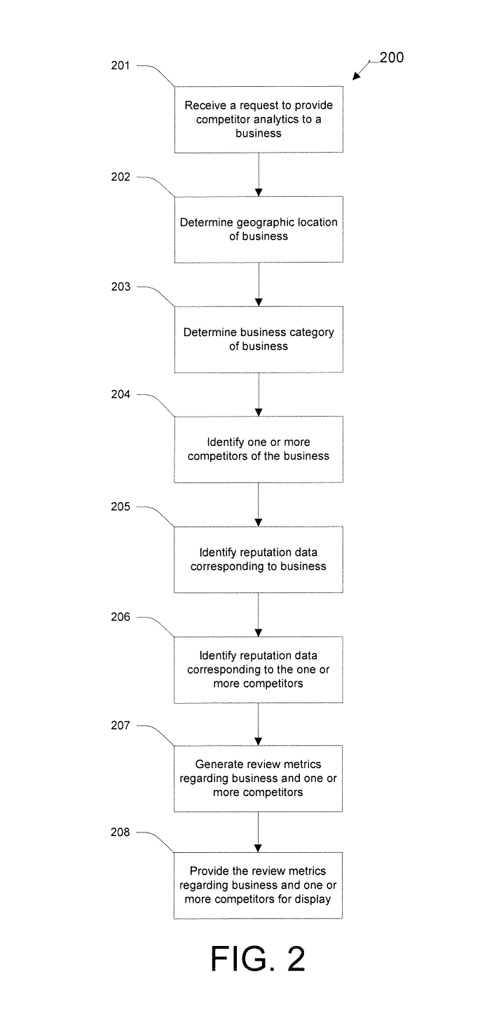

FIG. 2 illustrates a flow diagram of an example process 200 for providing competitor analytics to a business or an agent of the business (“user”). In block 201, a request to provide competitor analytics regarding a business is received. The request may be detected when a user logs into their business account, clicks to view competitor information or analytics or otherwise provides an indication of a request to view competitor analytics. “Competitor analytics,” as used herein, refer to metrics and information regarding the reputation and performance of the business and/or one or more competitors, groups of competitors or the competitor market.

In block 202, a geographic location of the business is determined. As described above, the geographic location of a business may be determined based on structure and/or unstructured data. The structured and/or unstructured data may include preexisting data and/or may be provided by the user in response to a query. Structured data provide explicit information indicating the geographic location of a business and may include address information, map information or other information providing the geographic location of a business. Unstructured information provide information that may not explicitly provide the geographic location of a business, but may provide some indication of geographic location, which may be used, for example, in combination with other information, to determine (e.g., estimate) the geographic location of a business. Unstructured information regarding geographic location of a business may, for example, include customer comments and or activity (e.g., check-in) which provides some location indication regarding the business, the geographic location of the customers, the geographic location of one or more competitors, geographic location of nearby locations, or other similar information. Based on the structured and/or structured data regarding the business, the geographic location of the business is determined in block 202.

In block 203, the business category associated with the business is determined. The business category of a business may refer to the type of business that the business operates in. In some implementations, a predefined set of business categories may be defined and each business, based on structured and/or unstructured information, may be classified into one of the business categories. In one example, the business category of the user may be explicitly provided by the user in response to a query. Structured category data refer to data specifically indicating business category. Unstructured category data, while providing some indication of business category, may not explicitly be stated as a specific category of business and may include types of products or services, business type information, content of reviews and/or user feedback, and/or other similar indicators of the business category of the business.

In block 204, one or more competitors of the business are identified. In one example, one or more competitors are identified based on the geographic location of the business determined in block 202 and/or the business category of the business determined in block 203. For example, a competitor is identified as a business operating in a same or similar business category as the business and/or within a geographic proximity (e.g., same region, same city, same state, same country). The geographic proximity of two businesses may be dependent on various factors including the business category, business type (e.g., online business vs. mom and pop store), size of the business and business market (e.g., national, international, region specific), and other similar data. In one example, geographic location and/or business category for each of one or more businesses is determined (e.g., similar to blocks 202 and 203) and based on the determination, one or more businesses are selected as competitors. In another example, the user (e.g., business agent) may indicate one or more businesses, geographic locations and/or business categories and the competitors may be identified at least in part based on user indications.

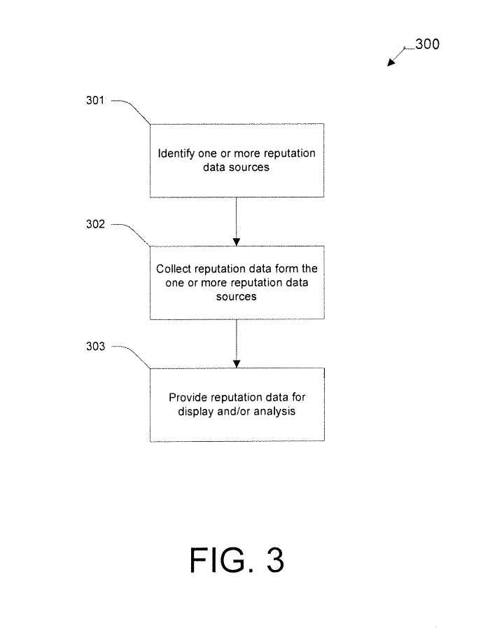

In block 205, reputation data regarding the business is collected from one or more data sources. In block 206, reputation data regarding the one or more competitors identified in block 204 is collected from one or more data sources. FIG. 3, described in more detail below, illustrates a flow diagram of an example process for providing reputation data regarding a business (e.g., the business and/or one or more competitors).

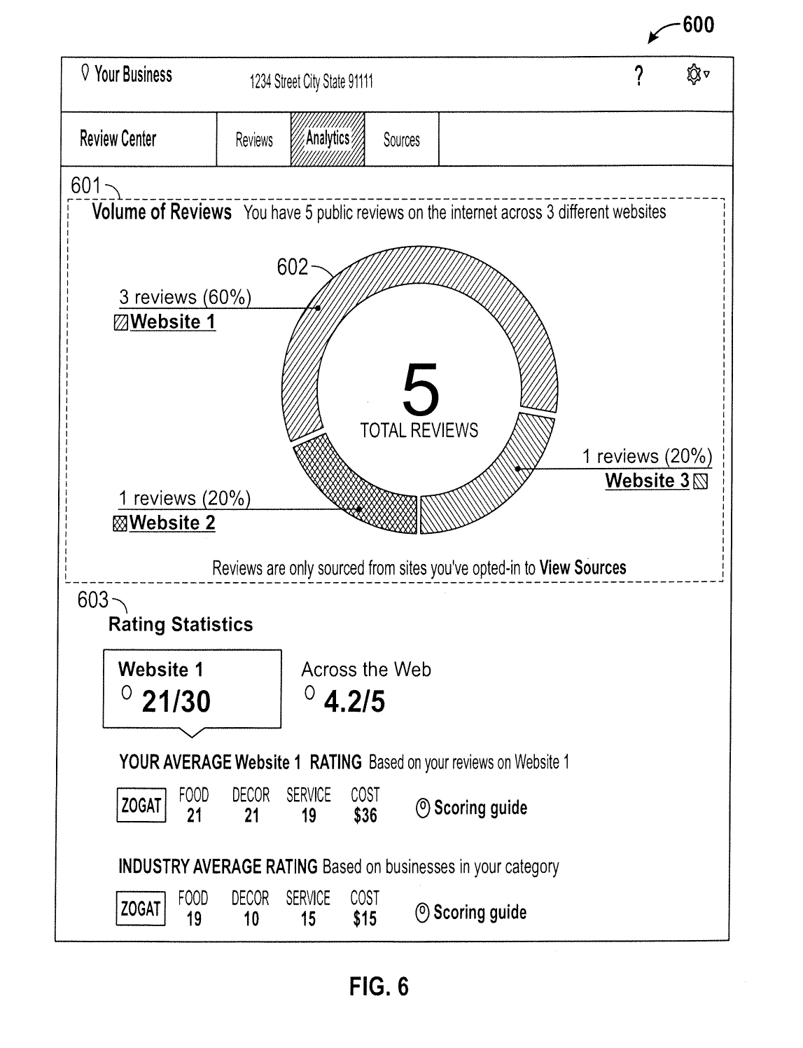

In block 207, one or more reputation metrics are generated from the data collected in blocks 205 and/or 206. The reputation metrics may include information including the number of reviews, comments, endorsements and/or recommendations, average ratings, rating statistics, an other such information and metrics regarding the business and/or one or more competitors. In one example, the metrics may compare the business to one or more competitors or may provide information regarding the business and one or more competitors separately such that the user is able to compare the information (e.g., side by side). In block 208, the reputation metrics are provided for display to the business. FIG. 6, described in more detail below, illustrates an example graphical user interface displaying competitor analytics.

FIG. 3 illustrates a flow diagram of an example process 300 for providing reputation data regarding a business. In block 301, one or more data sources for reputation data are identified. In one example, data sources for reputation data may include one or more sites providing users (e.g., customers) with mechanisms to provide opinions regarding the business, where such opinions provide an indication of the reputation of the business. For example, the data sources may include one or more web pages and/or applications providing mechanisms for endorsing, commenting on, recommending, reviewing or otherwise providing information regarding a business bearing on the reputation of the business or providing an indication of the quality of the business (e.g., one or more social networking sites, review services, recommendation services).

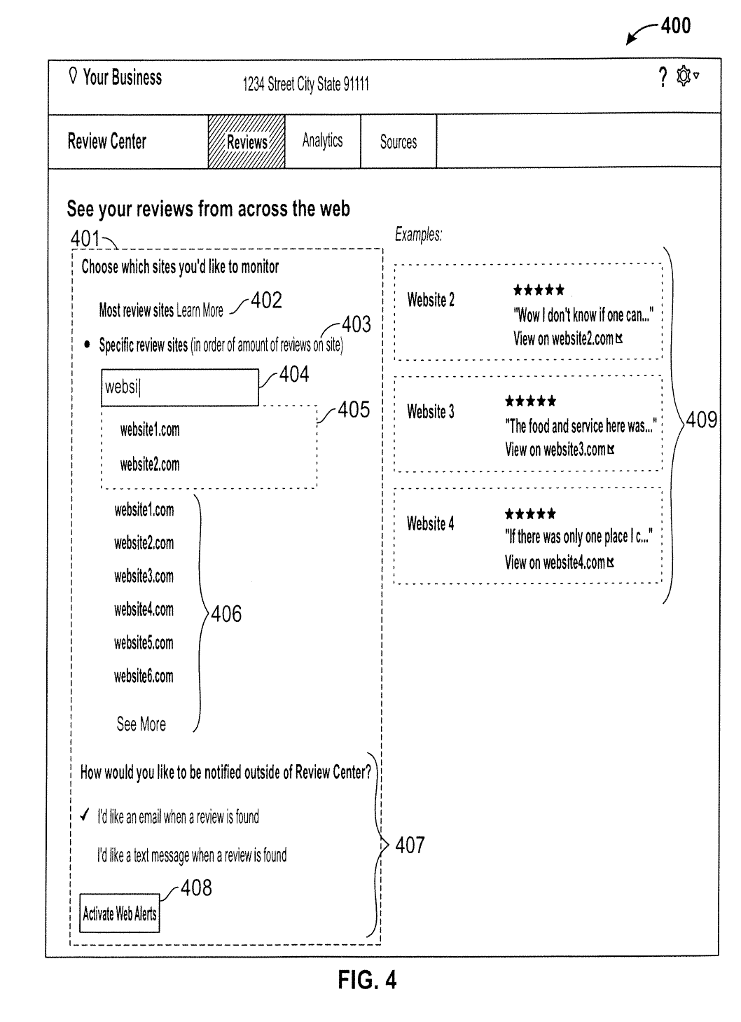

Data sources may be identified based on various criteria including most popular data sources (e.g., based on number visits, reviews, etc.), most significant data sources (e.g., based on quality of reviews, popularity of data source for market, etc.), and/or may be selected specifically by a user for monitoring. FIG. 4, described in more detail below, illustrates an example graphical user interface for selecting one or more data sources for monitoring.

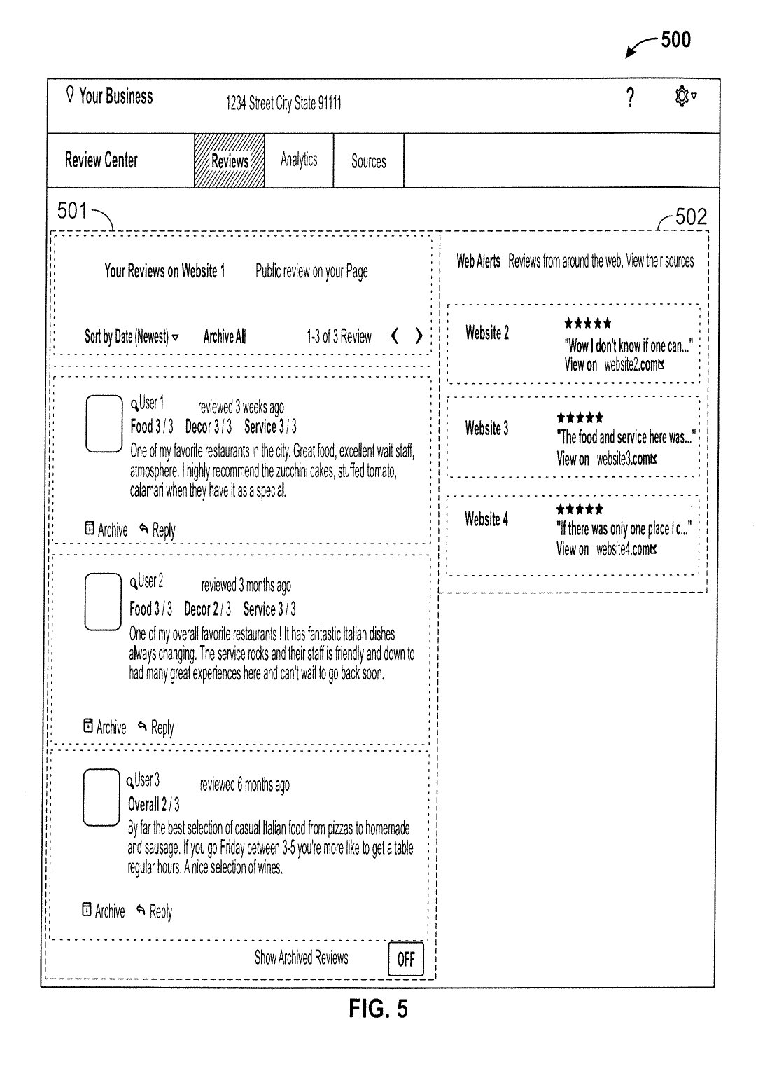

In block 302, reputation data regarding a business (e.g., the business and/or one or more competitors of the business) is collected from the one or more data sources. The reputation data may include both content of such comments/reviews and/or number of reviews, comments, endorsements, average rating, etc. The one or more data sources may be crawled for reputation data and the data may be collected and/or analyzed by the crawler or other entity in communication with the crawler. In block 303, the reputation data is provided for display, analysis or to generate one or more metrics for display to the user. In one example, the reputation data regarding the business may be provided for display to the user. The user may request to view reputation data (e.g., reviews) regarding the business at one or more data sources. In such examples, the one or more data sources may be monitored for reputation data (e.g., reviews, comments, endorsements) and the information may be provided for display to the user. FIG. 5, described in more detail below, illustrates an example graphical user interface for providing reputation data regarding a business for display. In some examples, the reputation data is used to generate competitor analytics displayed to the user, for example, as described in blocks 207 and 208 of process 200 of FIG. 2. FIG. 6, described in more detail below, illustrates an example graphical user interface displaying competitor analytics.

IV. Example Graphical User Interfaces for Providing a Business with Competitor Analytics

FIG. 4 illustrates an example graphical user interface 400 for selecting one or more data sources for monitoring. Graphical user interface 400 displays a reputation data source selection area 401. The reputation data source selection area provides various options for selecting data sources. In this example, the reputation data source selection area provides a first selection option 402 for selecting most review sites. This may include all review sites known, and/or those with the highest score (e.g., based on popularity, number of reviews/reviewers, relativity to business/business category, reputation of data source, etc.). A second selection option 403 allows the user to select specific review sites. A text box 404 is provided, allowing the user to enter a reputation data source identifier. As shown, once the user begins to enter a reputation data source identifier, an auto-complete box 405 may display one or more reputation data sources matching the entered identifier by the user. The user may then select one or more of the sites shown in the box. In addition, a list 406 of one or more reputation data sources is also displayed within the reputation data source selection area. The listing includes a listing of one or more reputation data sources and may include all available reputation data sources, and/or those with the highest score (e.g., based on popularity, number of reviews/reviewers, relativity to business/business category, reputation of data source, etc.).

Additionally an alert selection area 407 is provided for the user to select whether and/or how to be alerted when new reputation data is available. Once the user has made the selection, the user can use the “activate web alerts” to begin receiving alerts. The user interface 400 further includes examples of reputation data 409, showing the types of reputation data that is available. The examples may be related to the business (or competitors) or may be example reputation data randomly selected at the data sources.

FIG. 5 illustrates an example graphical user interface 500 for providing reputation data regarding a business. User interface 500 includes a reputation data display area including a specific reputation data source display area 501 and a overall reputation data display area 502. The specific data source display area 501 displays reputation data (e.g., reviews) collected from a selected data source (e.g., selected by the user or system administrator, the most popular or highest scoring review site, a most significant review site, etc.). The overall reputation data display area 502 displays reputation data regarding a business (e.g., user's own business and/or competitors) from across the web. The reputation data in this area may be from all data sources, highest ranking (scoring) data sources, most important data sources or specific data sources selected by the user, system administrator or other entity.

FIG. 6 illustrates an example graphical user interface 600 displaying competitor analytics. The analytics shown here display analytics data regarding the reputation of a specific business. The business may be the user's own business or one of one or more competitors of the user. In other examples, the analytics may provide side by side analytics for one or more businesses within the same graphical user interface. As shown, user interface 600 includes a first chart 602 shown within area 601 showing the volume of reputation data (e.g., reviews) relating to a business at one or more reputation data sources (e.g., all data sources or selected data sources) and/or a breakdown of the reputation data at each data source or group of data sources. A second ratings statistics area 603 displays information regarding the ratings of the user at one or more specific data sources or a combined rating at a collection of data sources (e.g., all available data sources or selected data sources). The rating statics area may further break down specific ratings for specific characteristics of the business at one or more data sources including for example food, décor, service, cost or other characteristics relating to a business.

V. Example System for Providing a Business with Competitor Analytics

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

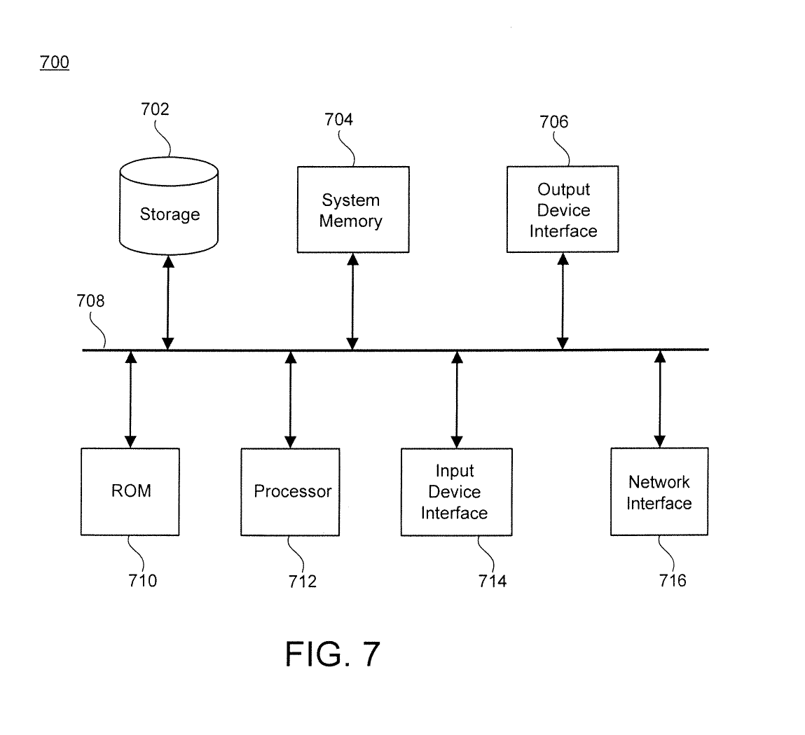

FIG. 7 conceptually illustrates an electronic system with which some implementations of the subject technology are implemented. Electronic system 700 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for providing competitor analytics. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of exemplary approaches. Based upon design preferences, it is understood that the specific order or hierarchy of blocks in the processes may be rearranged, or that some illustrated blocks may not be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer implemented method for providing a business with reputation data, the method comprising:
receiving, at one or more computing devices, a user selection of a reputation data source;
receiving, at the one or more computing devices, a request to provide a business with competitor analytics regarding the business;
identifying, using the one or more computing devices, one or more competitors of the business, wherein each of the one or more competitors of the business comprise a business;
monitoring, using the one or more computing devices, the user-selected reputation data source for reputation data corresponding to the business and the one or more competitors;
collecting, using the one or more computing devices, from the user-selected reputation data source the reputation data corresponding to the business;
generating, using the one or more computing devices, review metrics regarding the business based on the reputation data corresponding to the business;
collecting, using the one or more computing devices, from the user-selected reputation data source the reputation data corresponding to the one or more competitors;
generating, using the one or more computing devices, review metrics regarding the one or more competitors based on the reputation data corresponding to the one or more competitors; and
providing, using the one or more computing devices, the review metrics regarding the business and the review metrics regarding the one or more competitors for display in response to the request.

2. The method of claim 1, wherein identifying the one or more competitors comprises, receiving a selection of a first business of one of the one or more competitors from a user associated with the business, the selection indicating that the first business is a competitor of the business.

3. The method of claim 1, wherein identifying the one or more competitors comprising identifying at least one of the one or more competitors based on information regarding the business.

4. The method of claim 3, wherein the information regarding the business comprises a geographic location of the business.

5. The method of claim 4, wherein the identifying the one or more competitors comprises identifying one or more businesses having a geographic location that is proximate to the geographic location of the business.

6. The method of claim 3, wherein the information regarding the business comprises a business category of the business.

7. The method of claim 6, wherein the identifying the one or more competitors comprises identifying one or more businesses associated with a business category that is the same as the business category of the business.

8. The method of claim 5, further comprising determining the business category of the business based on information relating to the business.

9. The method of claim 1, wherein the reputation data comprises one or more of comments, reviews or ranking regarding the business or one or more competitors provided by one or more consumers, the user-selected reputation data source maintaining reputation data regarding one or more businesses.

10. The method of claim 1, wherein the review metrics regarding the business include one or more of a total number of reviews at the user-selected reputation data source or an average ranking of one or more of the business or one or more competitors at the user-selected reputation data source.

11. (canceled)

12. The method of claim 1, further comprising providing the reputation data corresponding to the business for display to the user.

13. The method of claim 1, further comprising providing reputation data corresponding to the one or more competitors for display to the user.

14. A system for providing a business with reputation data, the system comprising:
one or more processors; and
a machine-readable medium comprising instructions stored therein, which when executed by the processors, cause the processors to perform operations comprising:
receiving a user selection of a reputation data source;
receiving a request to provide a business with competitor analytics;
identifying one or more competitors of the business according to the geographic location of the business and business category associated with the business, wherein each of the one or more competitors of the business comprise a business;
monitoring the user-selected reputation data source for reputation data corresponding to the business and the one or more competitors;
collecting from the user-selected reputation data source the reputation data corresponding to the business and the one or more competitors; and
generating review metrics regarding one or more of the business and the one or more competitors based on the reputation data.

15. The system of claim 14, the operations further comprising providing the review metrics for display in response to the request.

16. The system of claim 14, the operations further comprising providing the reputation data corresponding to one or more of the business or one or more competitors for display to the user.

17. The system of claim 14, wherein the review metrics include one or more of a total number of reviews at the user-selected reputation data source or an average ranking of one or more of the business or one or more competitors at the user-selected reputation data source.

18. A non-transitory machine-readable medium comprising instructions stored therein, which when executed by a machine, cause the machine to perform operations comprising:
receiving a user selection of a reputation data source;
receiving a request to provide a business with competitor analytics regarding the business;
identifying one or more competitors of the business, wherein each of the one or more competitors of the business comprise a business;
monitoring the user-selected reputation data source for reputation data corresponding to the business and the one or more competitors;
collecting from the user-selected reputation data source the reputation data corresponding to the business and one or more competitors of the business;
generating review metrics regarding one or more of the business and the one or more competitors of the business based on the reputation data; and
providing the review metrics regarding the business and the review metrics regarding the one or more competitors for display in response to the request.

19. The machine-readable medium of claim 18, wherein the reputation data comprises one or more of comments, reviews or ranking regarding the business or one or more competitors provided by one or more consumers, the user-selected reputation data source maintaining reputation data regarding one or more businesses.

20. The machine-readable medium of claim 18, wherein identifying the one or more competitors comprising identifying at least one of the one or more competitors based on information regarding the business, wherein the information regarding the business comprises the geographic location of the business and a business category of the business.

21. The method of claim 1, further comprising providing for display, using the one or more computing devices, an interface for receiving user selections of one or more reputation data sources, the interface allowing a user to select a reputation data source from a predetermined list or input a source identifier associated with a reputation data source.
